(19) United States
(12) Patent Application Publication
(10) Pub. No.: US 2015/0353698 A1
(43) Pub. Date: Dec. 10, 2015

(54) METHOD FOR PRODUCING A PLASTIC ARTICLE WITH A HYDROPHOBIC GRAFT COATING AND PLASTIC ARTICLE

(71) Applicant: POLYAN GESELLSCHAFT ZUR HERSTELLUNG VON POLYMEREN FÜR SPEZIELLE ANWENDUNGEN UND ANALYTIK MBH, Berlin (DE)

(72) Inventors: Heike MATUSCHEWSKI, Neuenhagen (DE); Uwe SCHEDLER, Neuenhagen (DE)

(73) Assignee: POLYAN GESELLSCHAFT ZUR HERSTELLUNG VON POLYMEREN FÜR SPEZIELLE ANWENDUNGEN UND ANALYTIK MBH, Berlin (DE)

(21) Appl. No.: 14/759,562

(22) PCT Filed: Dec. 17, 2013
(86) PCT No.: PCT/EP2013/076846

§ 371 Date: Jul. 7, 2015

(30) Foreign Application Priority Data
Jan. 8, 2013 (DE) 10 2013 200 120.7

(51) Int. Cl. C08J 7/06; B01D 61/02; B01D 61/36; C08J 7/12; B01D 67/00

(52) U.S. Cl. CPC C08J 7/065; C08J 7/123; B01D 67/0093; B01D 61/366; B01D 61/027; C08J 2333/20; B01D 2323/345

(57) ABSTRACT

A method for producing a plastic article comprising the steps of:
(a) loading a surface of a polymeric substrate with an initiator that can be activated thermally or excited by light and which is suitable for generating radicals on the surface of the substrate,
(b) loading the substrate, with at least one hydrophobic, polymeric or monomeric grafting reagent capable of polymerization which, as a homopolymer, has a static contact angle with water of at least 75°, measured at 25° C., and which is suitable for reacting with the radicals generated on the surface of the substrate while forming a covalent bond, and
(c) exciting or activating the initiator so that the initiator generates radicals on the surface of the substrate and the grafting reagent forms a (three-dimensional) polymer structure that is covalently bonded to the surface of the substrate.

A plastic article that can be produced by the method.

The invention relates to a method for producing a plastic article comprising a polymeric substrate and a three-dimensional, hydrophobic polymer structure that is covalently bonded to the substrate. The invention further relates to a plastic article that can be produced by the method, which in particular can be a separating membrane.

The chemical and/or physical properties of the surfaces of plastic articles are often not suitable or not entirely suitable for the intended use of the article. For this reason, it is known to modify polymeric surfaces either chemically or physically. In particular, surfaces are often provided with coatings which are connected to the polymeric material of the article (substrate) either covalently (by means of chemical bonds) or non-covalently by means of physical interactive effects.

A technological field where surface modification is of particular interest are membranes for material separation (separating membranes), in particular filtration membranes (especially for ultrafiltration or nanofiltration) or pervaporation membranes. Filtration membranes serve to separate substances from a liquid medium due to their size and concentrate them. For example, ultrafiltration membranes separate out particles or macromolecular substances with particle diameters ranging from 0.01 to 0.1 μm, while nanofiltration serves to separate out particles or molecules with diameters from 0.001 to 0.01 μm (1 to 10 nm). To this end, the filtration membranes have suitable pore diameters. Pervaporation membranes, on the other hand, separate two liquid media from each other. In particular, a minor component (e.g. an impurity) is removed from a liquid medium (mixture of several liquid components) by said minor component diffusing across the membrane and evaporating on the other side of the membrane. Both pervaporation membranes and nanofiltration membranes are virtually impermeable. A typical example of use of pervaporation is the removal of water from organic solvents. The component which passes through the membrane is referred to as permeate and the liquid medium which remains on the other side of the membrane is referred to as retentate, in the context of filtration as well as pervaporation techniques.

The properties of a separating membrane must be adapted to the specific separating problem. To separate hydrophobic substances from a medium, for example, hydrophobic membranes are usually required. However, many polymer materials which are used for separating membranes are hydrophilic, so that the surface of the membrane must be modified such that it becomes hydrophobic in order to separate out hydrophobic materials. On the other hand, the membranes must of course be chemically stable in their respective environment. In particular they must not be soluble in the media used, capable of uncontrolled swelling, i.e. able to absorb or dissolve (major amounts of) liquids/solvents or gases, or chemically react with these. To this end, the surface must often be modified too.

To produce impermeable nanofiltration or pervaporation membranes, it is known to coat ultrafiltration membranes in such a manner that a quasi-impermeable porous structure is obtained. Usually, as mentioned above, the type of the coating is adapted to the intended use of the membrane.

DE 195 07 584 C2 describes a method for modifying the surface of separating membranes, in particular of composite membranes, which consist of a carrier membrane, for example made of polyvinylidene fluoride, and an adhesive (non-covalently attached) coating of polydimethylsiloxane (PDMS). To increase the membrane's resistance to solvents and to reduce its capability of swelling in the solvents used, the membrane is irradiated with low-energy electrons, causing cross-linking of the silicone separating layer.

From EP 0 811 420 A, a method for applying a graft polymerization layer to a polymeric carrier membrane is known. To this end, the carrier membrane is coated with a photoinitiator which, after excitation by light, is able to generate radicals on the polymer surface by the abstraction of hydrogen. Subsequently, the membrane is placed in a solution of a monomer and exposed to UV light, so that the monomer reacts covalently with the radicals generated on the polymer surface and polymerizes while forming polymer chains that are bonded to the membrane.

EP 1 102 623 A (=DE 198 36 108 A) describes to adapt the hydrophilicity or hydrophobicity of the photoinitiator used to the carrier material for the purpose of heterogeneous graft copolymerization.

It has shown that it is not possible, or only possible to an unsatisfactory extent, to produce hydrophobic layers using the known graft copolymerization methods.

The object of the invention is therefore to propose a method for producing plastic articles with a hydrophobic graft coating, wherein hydrophobic coating is done with a high degree of grafting. The aim is that the articles produced in this way, in particular separating membranes, have a correspondingly high hydrophobicity.

This object is achieved by a method and a plastic article having the features of the independent claims.

The method of the invention comprises the steps of:
(a) loading a surface of a polymeric substrate with an initiator that can be activated thermally or excited by light and which is suitable for generating radicals on the surface of the substrate, i.e. on the polymer of the substrate, after excitation, said initiator being adsorbed from a first solvent on the surface of the substrate,
(b) loading the substrate, from which the first solvent has substantially been removed and on which the initiator has been adsorbed, with at least one hydrophobic, polymeric or monomeric grafting reagent capable of polymerization which, as a homopolymer, has a static contact angle with water of at least 75°, measured at 25° C., and which is suitable for reacting with the radicals generated on the surface of the substrate while forming a covalent bond, said grafting reagent being used without a solvent or in an organic, second solvent, the solubility and/or the swelling of the substrate in the first solvent exceeding that in the grafting reagent or in the mixture of the second solvent and the grafting reagent,
(c) exciting the initiator by irradiating the surface of the substrate that has been loaded with the initiator and the grafting reagent with light of a suitable wavelength or activating the initiator by supplying heat, so that the initiator generates radicals on the surface of the substrate and the grafting reagent forms a (three-dimensional) polymer structure that is covalently bonded to the surface of the substrate.

It has shown that, when the above solubility relations are observed, the grafting reaction in step (c) takes place with a comparatively high degree of grafting, while only negligible or very little grafting could be achieved when these rules were disregarded. It seems that particular importance is attached to the relative solubility/capability of swelling of the substrate material in the first solvent on the one hand, and in the solvent-free grafting reagent or the mixture of the grafting reagent and the second solvent on the other. On the one hand, it is advantageous that the substrate swells well in the first solvent when the substrate is loaded with the initiator in step (a), which requires a certain (low) solubility or capability of swelling of the substrate in this solvent. This is because swelling of the substrate enables the initiator to penetrate into the swollen surface and to be absorbed in deeper layers of the substrate that are near the surface. On the other hand, the lower solubility/reduced swelling of the substrate in the (solvent-free) grafting reagent or the mixture of the grafting reagent and the second solvent leads to reduced swelling of the substrate surface in step (b). As a result, the initiator is retained on the substrate and a sufficient amount of the initiator remains on the substrate surface to react with the latter while forming radicals on the substrate. If, in contrast, the substrate swells strongly in step (b), the initiator is washed out of the substrate surface either partly or completely, as the solvent molecules penetrate into the polymer, causing it to swell and dissolving the initiator. The initiator can thus be transported out of the substrate by way of diffuse equilibriums.

It is further preferred that the solubility of the initiator in the first solvent exceed that in the grafting reagent or in the mixture of the second solvent and the grafting reagent. This comparatively low solubility of the photoinitiator in the grafting reagent or in the mixture of the second solvent and the grafting reagent also leads to a reduced washing out of the initiator from the substrate surface and thus to an improved degree of grafting. If the above solubility relations are disregarded, the main result obtained is a homopolymerization of the grafting reagent instead of the desired covalent bonding to the substrate.

The solubility of a first component in a second component can be predicted using the so-called Hansen parameters, for example. Each molecule is assigned three Hansen solubility parameters (dD, dP, dH), each of which is given in MPa^{0.5}. dD is the intermolecular dispersion energy (van der Waals forces), dP is the energy of intermolecular dipole forces and dH is the energy of intermolecular hydrogen bridges. In a Cartesian coordinate system of these Hansen solubility parameters, the values of dD, dP and dH of a component form a vector. The closer the vectors of two components are to each other, the higher is the solubility of the components in each other. As an alternative, the octanol-water distribution coefficients (K_{OW} or better log K_{OW}) or other parameters, such as the dipole moment or E_{T} values, can be used to estimate the solubility. Of course, a precise determination by means of measurements is also possible.

In the context of the present invention, the term “hydrophobic” is understood as the property of a material to repel water. The quantitative measure of the hydrophobicity or hydrophilicity of a material is the static angle of contact of a drop of water on a plane surface of the material. Herein materials with a contact angle of water of at least 75° at 25° C. are defined as hydrophobic, while those with a contact angle below 75° are defined as hydrophilic.

In the context of the present invention, “loading of the surface” in steps (a) and (b) is understood to mean any form of contacting the surface to be coated with the respective substance (initiator or grafting reagent). This can be done by immersing the substrate in the substance, applying a layer of the substance to the surface, spraying or painting the surface with the substance, etc. The essential requirement is that direct contact be made between the surface to be coated and the respective substance, so that both can interact with each other.

Preferably the grafting reagent is used without addition of a solvent in step (b), i.e. applied to the substrate surface in an undissolved, pure form.

Since most initiators are solids and moreover only relatively low concentrations per unit area of the initiator are required, the initiator is used in the presence of the first solvent, in particular in the form of a solution. Before the surface is loaded with the grafting reagent in step (b), the first solvent is at least substantially removed, which means herein that the substrate seems dry upon visual inspection. In particular, the first solvent is removed to such an extent that the increase in mass of the substrate caused by the solvent is max. 10%, in particular max. 5%, preferably max. 1%, relative to the mass of the dry substrate. This can be done by drying in air or in a protective atmosphere and, if appropriate, by heating and/or at negative pressure. The removal of the solvent leads to an even more intense contact of the initiator with the polymeric surface of the substrate and thus to a further increase of the radical density obtained on the substrate.

The initiator used in step (a) of the method is suitable for generating radicals on the polymer of the substrate which form the “point of connection” for the subsequent reaction of the grafting reagent. The term “radical” is understood to mean at least one “unpaired”, i.e. free, electron or a combination including such an electron. In the context of the present invention, “radicals” comprise non-ionic radicals as well as ionic radicals (radical ions, i.e. radical cations and anions).

Initiators that are capable of forming radicals comprise carbonyl compounds, in particular ketones and especially α-aromatic ketones, such as benzophenones, for example benzophenone dicarboxylic acid or methylbenzophenone; fluorenones and α- and β-naphthyl compounds and derivatives of the aforesaid compounds. Further examples of suitable radical-forming initiators are mentioned in EP 0 767 803 A, for instance.

Although in the context of the present invention use can also be made of initiators that can be activated thermally, a photoinitiator that can be excited by light of a suitable wavelength is preferably used. It is particularly preferred that said photoinitiator be of the H abstraction type which is suitable for abstracting hydrogen radicals from the substrate after excitation by light. In this way, radicals remain in the polymer material, which react with the grafting reagent. Suitable H abstraction photoinitiators can be selected from the substances mentioned above, in particular from the group of α-aromatic ketones. The advantage of H abstraction photoinitiators is that these are able to react with polymer materials which include abstractable hydrogens, i.e. with virtually all organic polymer materials. In addition, the abstraction of hydrogen radicals is a particularly gentle initialization of a grafting reaction with few side reactions. If an initiator of the H abstraction type is used, the second solvent—if any—used in step (b) is preferably an aprotic solvent, in order to avoid a reaction of the initiator with the solvent.

Polymer materials of the substrate to be coated which can be used in the context of the present invention are not limited to specific polymers. In particular, use is made of synthetic, organic polymers, for example polyolefins, such as polyethylene, polypropylene, etc., polysulphones, polyamides, polyesters, polycarbonates, poly(meth)acrylates, polyacrylamides, polyacrylonitriles, polyvinylidene fluorides, or natural (optionally modified), organic polymers, such as celluloses, amylose, agarose, as well as derivatives, copolymers or blends of the aforesaid polymers.

It has further proven advantageous to select polymeric grafting reagents which in particular have a weight average molar mass of at least 400 g/mol, in particular of at least 800 g/mol, preferably of at least 2,000 g/mol. On the other hand, the molar mass of the polymer should not exceed 50,000 g/mol, in particular 20,000 g/mol.

In the method of the invention, hydrophobic grafting reagents with static contact angles of at least 75° are used. Preferably the grafting reagent used, which may also comprise a mixture of more than one substance, has, as a homopolymer, a static contact angle of water of at least 90°, preferably of at least 100°, measured at 25° C. In some embodiments, hydrophobic grafting reagents with a contact angle of at least 110° are used in order to achieve corresponding hydrophobicities of the surface. In special embodiments, hydrophobic grafting reagents with a contact angle of up to 160° are used.

In general, the method of the invention is not limited to specific grafting reagents and basically all polymeric or monomeric grafting reagents with suitable hydrophobicities can be used. For example, polyolefins; poly(organo)siloxanes (silicones), for example polydimethoxysiloxane; alkyl (meth)acrylates, for example butyl acrylate; aryl (meth)acrylates, for example phenyl acrylate, fluorinated alkyl (meth)acrylates, fluorinated aryl (meth)acrylates or mixtures thereof can be used in the method.

Another requirement to be met by the grafting reagents is their suitability for reacting and polymerizing with the radicals generated on the substrate while forming a covalent bond. To this end, the monomeric or polymeric grafting reagent can have a reactive double bond, for example a (meth)acrylate group, a vinyl group or an allyl group. It is sufficient if one such reactive double bond in present, in particular at a terminal position of the polymer chain.

The grafting process which takes place in the context of the invention is a so-called “grafting from” process, where the grafting reagent initially reacts with the surface radicals of the substrate and then polymerizes with further grafting reagent molecules while forming a chain that is covalently bonded to the substrate. If the grafting reagent is a low-molecular monomer, a chain of the polymer formed from said monomer will “grow” on the substrate. If, however, the grafting reagent is a polymer, a main chain will typically “grow” on the substrate, which derives from the polymerized double bonds and to which the side chains of the polymer of the grafting reagent are bonded. In contrast to the foregoing, the so-called “grafting to” (or “grafting on”) process involves a reaction of the initiator with the substrate surface and then with the, usually polymeric, grafting reagent, which forms a covalent bond with the substrate but does not polymerize further. In the “grafting to” process, the initiator thus remains on the surface and is “incorporated” into the product.

According to another embodiment of the invention, a cross-linking agent for cross-linking the polymer chains of the grafting reagent is loaded onto the surface of the substrate in step (b) in addition to the grafting reagent. The use of a cross-linking agent increases the stability of the coating. The cross-linking agents used can be any substances which have at least two reactive groups that can be polymerized and are able to react with the grafting reagent. In a preferred embodiment, the cross-linking agent is a substance with the same chemical basis as the grafting reagent, for example polydimethoxysiloxane with two terminal reactive groups, in particular double bonds, if the grafting reagent is polydimethoxysiloxane. Preferably the molar mass of the cross-linking agent is in the order of magnitude of or near that of the grafting reagent. For example, if use is made of a (low-molecular) monomeric grafting reagent, a low-molecular monomeric cross-linking agent is preferably used, and in case of polymeric grafting reagents, a polymeric cross-linking agent is used. Preferably the polymeric cross-linking agent has the same molar masses indicated for the polymeric grafting reagent.

In general, the present invention is not limited to specific configurations of substrates. According to a preferred embodiment, the polymeric substrate used is a filtration membrane with a porous structure. In particular, an ultrafiltration membrane with an average pore size ranging from 5 to 50 nm, preferably ranging from 10 to 30 nm, can be used. In this case, the graft coating according to the invention, which also “seals” the pores, produces an impermeable membrane which can be used as a nanofiltration or pervaporation membrane.

Another aspect of the present invention relates to a plastic article which can be produced according to the method of the invention and comprises a polymeric substrate and a (three-dimensional) polymeric structure that is covalently bonded to the substrate. The article is characterized by a contact angle of water on the coating of at least 75°, in particular of at least 90° and preferably of at least 100°, at 25° C. In some embodiments, contact angles of at least 110° or more are achieved.

Preferably the plastic article is a filtration membrane, in particular a nanofiltration membrane or pervaporation membrane. In case of such a filtration membrane, the plastic article of the invention preferably has a degree of grafting in the range from 0.25 to 10 mg graft layer per cm² substrate area, in particular of at least 1 mg/cm² substrate area. Other articles which have a microscopically smooth surface without a porous structure tend to have a lower degree of grafting.

Due to the “grafting from” mechanism described above, the initiator is lo longer present in the product of the invention, in contrast to the “grafting to” mechanism.

Further preferred embodiments of the invention are obtained as a result of the other features mentioned in the subclaims.

The invention will now be explained in more detail in exemplary embodiments.

1. Production of PAN Membranes with Hydrophobic Coating

### 1.1. PAN-gr-CyHxMA

A polyacrylonitrile (PAN) ultrafiltration membrane (manufacturer: GKSS, thickness: 200 μm, average pore size: 10 nm) was coated on both sides with a solution of benzophenone (BP) in acetone (0.15 mol/l) by immersing the membrane in the benzophenone solution for 15 minutes. Subsequently the membrane was removed from the solution and dried at room temperature. To obtain the grafting reagent solution, cyclohexyl methacrylate (manufacturer: ABCR) (concentration: 200 g/l) was dissolved in toluol. The membrane which had been loaded with the photoinitiator was placed on a glass plate and a thin layer of the grafting reagent solution was applied to the membrane. The membrane which had been coated with the grafting reagent was left to rest for 30-60 minutes.

This was followed by UV irradiation with a radiation dose of 80 mJ/cm².

Finally the irradiated membrane was intensely washed with isopropanol in several steps in order to remove grafting reagents that were not covalently bonded to the membrane and by-products.

### 1.2. PAN-gr-CyHxMA-co-PEGMA

A polyacrylonitrile (PAN) ultrafiltration membrane (manufacturer: GKSS, thickness: 200 μm, average pore size: 10 nm) was coated on both sides with a solution of benzophenone (BP) in acetone (0.15 mol/l) by immersing the membrane in the benzophenone solution for 15 minutes. Subsequently the membrane was removed from the solution and dried at room temperature. To obtain the grafting reagent mixture, cyclohexyl methacrylate (manufacturer: ABCR) (concentration: 200 g/l) and monomethyl (PEG) methacrylate (manufacturer: Aldrich) (20 g/l) were dissolved in toluol. The membrane which had been loaded with the photoinitiator was placed on a glass plate and a thin layer of the grafting reagent mixture was applied to the membrane. The membrane which had been coated with the grafting reagent was left to rest for 30-60 minutes.

This was followed by UV irradiation with a radiation dose of 80 mJ/cm².

Finally the irradiated membrane was intensely washed with isopropanol in several steps in order to remove grafting reagents that were not covalently bonded to the membrane and by-products.

### 1.3. PAN-gr-ODMA

A polyacrylonitrile (PAN) ultrafiltration membrane (manufacturer: GKSS, thickness: 200 μm, average pore size: 10 nm) was coated on both sides with a solution of benzophenone (BP) in acetone (0.05 mol/l) by immersing the membrane in the benzophenone solution for 15 minutes. Subsequently the membrane was removed from the solution and dried at room temperature. A grafting reagent mixture of octadecyl methacrylate (manufacturer: ABCR) and Darocur TPO (manufacturer: Ciba) (concentration: 1%) was produced without addition of a solvent. The membrane which had been loaded with the photoinitiator was placed on a glass plate and a thin layer of the grafting reagent mixture was applied to the membrane. The membrane which had been coated with the grafting reagent was left to rest for 30-60 minutes.

This was followed by UV irradiation with a radiation dose of 80 mJ/cm².

Finally the irradiated membrane was intensely washed with isopropanol in several steps in order to remove grafting reagents that were not covalently bonded to the membrane and by-products.

### 1.4. PAN-gr-PFDMA

A polyacrylonitrile (PAN) ultrafiltration membrane (manufacturer: GKSS, thickness: 200 μm, average pore size: 10 nm) was coated on both sides with a solution of benzophenone (BP) in acetone (0.05 mol/l) by immersing the membrane in the benzophenone solution for 15 minutes. Subsequently the membrane was removed from the solution and dried at room temperature. To obtain the grafting reagent solution, perfluorodecyl methacrylate (manufacturer: Chempur) (concentration: 50 g/l) was dissolved in decanol. The membrane which had been loaded with the photoinitiator was placed on a glass plate and a thin layer of the grafting reagent solution was applied to the membrane. The membrane which had been coated with the grafting reagent was left to rest for 30-60 minutes.

This was followed by UV irradiation with a radiation dose of 60 mJ/cm².

Finally the irradiated membrane was intensely washed with isopropanol in several steps in order to remove grafting reagents that were not covalently bonded to the membrane and by-products.

### 1.5. PP-gr-TFEMA

A polypropylene (PP) microfiltration membrane (manufacturer: Membrana, thickness: 170 μm, average pore size: 0.2 μm) was coated on both sides with a solution of benzophenone (BP) in acetone (0.05 mol/l) by immersing the membrane in the benzophenone solution for 15 minutes. Subsequently the membrane was removed from the solution and dried at room temperature. The grafting reagent used was trifluoroethyl methacrylate (manufacturer: Chempur). The membrane which had been loaded with the photoinitiator was placed on a glass plate and a thin layer of the grafting reagent solution was applied to the membrane. The membrane which had been coated with the grafting reagent was left to rest for 30-60 minutes.

This was followed by UV irradiation with a radiation dose of 80 mJ/cm².

Finally the irradiated membrane was intensely washed with isopropanol in several steps in order to remove grafting reagents that were not covalently bonded to the membrane and by-products.

### 1.6. PAN-gr-PDMS

A polyacrylonitrile (PAN) ultrafiltration membrane (manufacturer: GKSS, thickness: 200 μm, average pore size: 10 nm) was coated on both sides with a solution of benzophenone (BP) in acetone (0.035-0.15 mol/l) by immersing the membrane in the benzophenone solution for 15 minutes. Subsequently the membrane was removed from the solution and dried at room temperature.

A grafting reagent mixture of polydimethylsiloxane monomethacryloxypropyl terminated (PDMS-MMA) (manufacturer: ABCR) and the cross-linking agent polydimethylsiloxane methacryloxypropyl terminated (PDMS-DMA) (manufacturer: ABCR) was produced without addition of a solvent. The membrane which had been loaded with the photoinitiator was placed on a glass plate and a thin layer of the grafting reagent mixture was applied to the membrane. The membrane which had been coated with the grafting reagent was left to rest for 30-60 minutes.

As an alternative, the grafting reagent mixture of PDMS-MMA and PDMS-DMA was applied to the membrane as a solution in toluol. The membrane which had been coated with the grafting reagent was left to rest for 30-60 minutes at room temperature.

This was followed by UV irradiation with a radiation dose of 45 to 80 mJ/cm².

Finally the irradiated membrane was intensely washed with isopropanol in several steps in order to remove grafting reagents that were not covalently bonded to the membrane and by-products.

The different approaches are summarized in Tables 1 and 2. The molar mass of the grafting reagent was varied. The tests involved both monomeric grafting reagents (Tests 1, 3-5) and polymeric grafting reagents (Table 2) as well as a mixture (Test 2). The concentration of the photoinitiator benzophenone was varied. In Tests 1, 2 and 10, the grafting reagent mixture used was provided in toluol. In Test 4, decanol was used as a solvent. The effect of the cross-linking agent PDMS-DMA was examined. The irradiation time was varied.

TABLE 1
Approaches to synthesis using different grafting reagents

| | | BP | | | Irradiation dose | DG | Contact |
|---|---|---|---|---|---|---|---|
| # | Substrate | [mol/l] | Monomer | S | (mJ/cm²) | [mg/cm²] | angle [°] |
| 1 | PAN | 0.15 | CyHxMA | Toluol | 80 | 2.24 | 93.2 |
| 2 | PAN | 0.15 | CyHxMA/PEGMA | Toluol | 80 | 6.28 | 83.1 |
| 3 | PAN | 0.05 | ODMA | — | 80 | 6.0 | 94.8 |
| 4 | PAN | 0.05 | PFDMA | Decanol | 60 | 4.26 | 150 |
| 5 | PP | 0.05 | TFEMA | — | 80 | 0.98 | 140 |

BP: benzophenone;
DG: degree of grafting;
S: solvent

TABLE 2
Approaches to synthesis using polydimethylsiloxane as a grafting reagent

| | | BP | PDMS-MMA | PDMS-DMA | PDMS-MMA: | | Irradiation dose | DG |
|---|---|---|---|---|---|---|---|---|
| # | Substrate | [mol/l] | [g/mol] | [g/mol] | PDMS-DMA | S | (mJ/cm²) | [mg/cm²] |
| 6 | PAN | 0.035 | 10,000 | 10,000 | 20:1 | — | 80 | 1.75 |
| 7 | PAN | 0.08 | 10,000 | 10,000 | 20:1 | — | 80 | 3.02 |
| 8 | PAN | 0.15 | 10,000 | 10,000 | 20:1 | — | 80 | 4.23 |
| 9 | PAN | 0 | 900 | 10,000 | 20:1 | — | 80 | 0.06 |
| 10 | PAN | 0.15 | 900 | 10,000 | 20:1 | Toluol | 80 | 1.36 |
| 11 | PAN | 0.15 | 10,000 | 10,000 | 20:1 | — | 80 | 4.58 |
| 12 | PAN | 0.15 | 10,000 | 10,000 | 20:1 | — | 60 | 3.99 |
| 13 | PAN | 0.15 | 10,000 | 10,000 | 20:1 | — | 45 | 3.59 |
| 14 | PAN | 0.15 | 900 | 10,000 | 20:1 | — | 80 | 1.39 |
| 15 | PAN | 0.15 | 10,000 | — | — | — | 80 | 2.98 |
| 16 | PAN | 0.08 | 10,000 | — | — | — | 80 | 2.43 |
| 17 | PAN | 0.035 | 10,000 | — | — | — | 80 | 0.92 |

BP: benzophenone;
DG: degree of grafting;
S: solvent;
PDMS-MMA: polydimethylsiloxane monomethacryloxypropyl terminated;
PDMS-DMA: polydimethylsiloxane methacryloxypropyl terminated

### 2. Properties of the Coated Membranes

The degree of grafting (DG) of the coated membranes was determined gravimetrically. The results are shown in Tables 1 and 2. Table 1 also shows the contact angles measured with water.

The coated PAN membranes listed in Tables 1 and 2 were used to carry out pervaporation tests. The tests involved the separation of an ethanol-water mixture. The ethanol concentration in the feed was 10 percent by mass.

In addition, the PDMS-coated PAN membranes listed in Table 2 were used to carry out nanofiltration tests. The tests involved the separation of a mixture of alkanes in toluol. The concentration of each of the individual alkanes in the feed was 0.25 percent by mass.

The results are compiled in Tables 3 and 4.

TABLE 3
Pervaporation tests

| | | | Increase in |
|---|---|---|---|
| | DG | Flux J | concentration β |
| # | [mg/cm²] | [kg/h · m²] | [—] |
| 1 | 2.24 | 1.64 | 2.67 |
| 2 | 6.28 | 3.18 | 2.20 |
| 13 | 3.59 | 0.21 | 3.97 |
| 14 | 1.39 | 1.46 | 3.86 |
| 15 | 2.98 | 0.35 | 3.98 |
| 16 | 2.43 | 0.43 | 3.79 |
| 17 | 0.92 | 1.53 | 3.98 |

TABLE 4
Nanofiltration tests

| | | | Retained | Retained | Retained |
|---|---|---|---|---|---|
| | DG | Permeability | C18 | C24 | C36 alkane |
| # | [mg/cm²] | [kg/h · m² · bar] | alkane [%] | alkane [%] | [%] |
| 11 | 4.58 | 0.05 | 30.90 | 52.79 | 89.47 |
| 12 | 3.99 | 0.06 | 20.97 | 47.93 | 88.97 |
| 13 | 3.59 | 0.12 | 18.41 | 47.09 | 85.80 |
| 14 | 1.39 | 1.43 | 30.04 | 49.84 | 89.52 |
| 15 | 2.98 | 0.13 | 26.71 | 47.50 | 85.09 |
| 16 | 2.43 | 0.30 | 12.43 | 29.29 | 57.40 |
| 17 | 0.92 | 4.30 | 16.99 | 25.15 | 56.71 |

The pervaporation tests (Table 3) show that in particular the amount of permeate can be controlled. There are only minimal changes in selectivity.

The degree of grafting on the one hand and the performance of the membrane in nanofiltration (Table 4) on the other are controlled by varying the respective reaction parameters (Table 2).

1. A method for producing a plastic article comprising a polymeric substrate and a hydrophobic polymer structure that is covalently bonded to the substrate, comprising the steps of:
(a) loading a surface of a polymeric substrate with an initiator that can be activated thermally or excited by light and which is suitable for generating radicals on the surface of the substrate after excitation, said initiator being adsorbed from a first solvent on the surface of the substrate,
(b) loading the substrate, from which the first solvent has substantially been removed and on which the initiator has been adsorbed, with at least one hydrophobic, polymeric or monomeric grafting reagent capable of polymerization which, as a homopolymer, has a static contact angle with water of at least 75°, measured at 25° C., and which is suitable for reacting with the radicals generated on the surface of the substrate while forming a covalent bond, said grafting reagent being used without a solvent or in an organic, second solvent, the solubility and/or the swelling of the substrate in the first solvent exceeding that in the grafting reagent or in the mixture of the second solvent and the grafting reagent, and
(c) exciting the initiator by irradiating the surface of the substrate that has been loaded with the initiator and the grafting reagent with light of a suitable wavelength or activating the initiator by supplying heat, so that the initiator generates radicals on the surface of the substrate and the grafting reagent forms a polymer structure that is covalently bonded to the surface of the substrate.

2. The method according to claim 1, wherein a solubility of the initiator in the first solvent preferably exceeds that in the grafting reagent or in the mixture of the second solvent and the grafting reagent.

3. The method according to claim 1, wherein, before step (b), the first solvent is removed at least to such an extent that the increase in mass of the substrate caused by the solvent is max. 10%, in particular max. 5%, preferably max. 1%, relative to the dry substrate.

4. The method according to claim 1, wherein the initiator is a photoinitiator of the H abstraction type which is suitable for abstracting hydrogen radicals from the substrate after excitation by light.

5. The method according to claim 4, wherein the H abstraction photoinitiator is a ketone, in particular benzophenone or a derivative thereof.

6. The method according to claim 1, wherein the grafting reagent is a polymeric grafting reagent and has a weight average molar mass of at least 400 g/mol, in particular of at least 800 g/mol, preferably of at least 2,000 g/mol.

7. The method according to claim 1, wherein the grafting reagent, as a homopolymer, has a static contact angle of water of at least 90°, preferably of at least 100°, particularly preferred of at least 110°, measured at 25° C.

8. The method according to claim 7, wherein the grafting reagent is selected from polyolefins, poly(organo)siloxanes, alkyl (meth)acrylates, aryl (meth)acrylates, fluorinated alkyl (meth)acrylates, fluorinated aryl (meth)acrylates or mixtures thereof.

9. The method according to claim 1, wherein, in step (b) in addition to the grafting reagent, the surface of the substrate is loaded with a cross-linking agent which is suitable for cross-linking polymer chains formed by the grafting reagent.

10. The method according to claim 1, wherein the polymeric substrate is a separating membrane with a porous structure, in particular an ultrafiltration membrane with an average pore size ranging from 5 to 50 nm, preferably ranging from 10 to 30 nm.

11. A plastic article comprising a polymeric substrate and a hydrophobic polymer structure that is covalently bonded to the substrate, which article can be produced by a method according to claim 1, characterized by a static contact angle of water on the covalently bonded polymer structure of at least 75°, measured at 25° C.

12. The plastic article according to claim 11, wherein the article is a nanofiltration membrane or a pervaporation membrane.
